(19) United States
(12) Patent Application Publication
(10) Pub. No.: US 2026/0238259 A1
(43) Pub. Date: Aug. 13, 2026

(54) TWO-SIDE META-ELEMENT COEFFICIENTS ASSOCIATION IN HYBRID-RIS BASED COMMUNICATION

(71) Applicant: QUALCOMM Incorporated, San Diego, CA (US)

(72) Inventors: Min HUANG, Beijing (CN); Mingxi YIN, Beijing (CN); Hao XU, Beijing (CN)

(21) Appl. No.: 19/161,214

(22) PCT Filed: Mar. 22, 2023
(86) PCT No.: PCT/CN2023/083005

§ 371 Date: Aug. 29, 2025

(51) Int. Cl. H04B 7/04; H04B 7/0417

(52) U.S. Cl. CPC H04B 7/04013; H04B 7/0417

(57) ABSTRACT

A network entity (e.g., a base station) may identify a meta-element coefficient association for a network node (e.g., an H-RIS). The network entity may transmit, for the network node, an indication of the meta-element coefficient association. The network node may identify a plurality of meta-element coefficients based on the meta-element coefficient association and at least one reference signal. The network node may forward a channel from the network entity for a UE or from the UE for the network entity based on the plurality of meta-element coefficients and a one-sided operation or a two-sided operation.

### TECHNICAL FIELD

The present disclosure relates generally to communication systems, and more particularly, to configuration of a hybrid reconfigurable intelligent surface (H-RIS) in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a network node. The apparatus may receive an indication of a meta-element coefficient association from a network entity. The apparatus may identify a plurality of meta-element coefficients based on the meta-element coefficient association and at least one reference signal. The apparatus may forward a channel from the network entity for a user equipment (UE) or from the UE for the network entity based on the plurality of meta-element coefficients and a one-sided operation or a two-sided operation.

In an aspect of the disclosure, a method, a computer-readable medium, and an apparatus are provided. The apparatus may be a network entity. The apparatus may identify a meta-element coefficient association for a network node. The apparatus may transmit, for the network node, an indication of the meta-element coefficient association. The apparatus may communicate with a UE via the network node based on a plurality of meta-element coefficients and a one-sided operation or a two-sided operation at the network node. The plurality of meta-element coefficients may be based on the meta-element coefficient association and at least one reference signal. A channel may be forwarded from the network entity for the UE or from the UE for the network entity via the network node based on the plurality of meta-element coefficients and the one-sided operation or the two-sided operation at the network node.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating the operation of example RISs.

FIG. 5 is a diagram illustrating reflective beamforming by a RIS.

FIG. 6 is a diagram illustrating beamforming by an example transmissive RIS in the far field.

FIG. 7 is a diagram illustrating the operation of an example H-RIS.

FIG. 8 is a diagram illustrating radiation patterns of example H-RISs.

FIG. 9 is a diagram of a communication flow of a method of wireless communication.

FIG. 10 is a diagram illustrating an incident angle θᵢ, a reflective angle θᵣ, and a transmissive angle θₜ associated with an example H-RIS.

FIG. 11 is a diagram illustrating the beamforming gain associated with an example H-RIS.

FIG. 12 a diagram of a communication flow of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example network entity.

FIG. 18 is a diagram illustrating an example of a hardware implementation for an example network entity.

### DETAILED DESCRIPTION

An H-RIS may implement simultaneous reflection and transmission. The protocol and control signaling for efficient usage of an H-RIS in a wireless network may be useful. For the H-RIS, whether to perform a single-sided beam sweeping or a two-sided beam sweeping may depend on the capability of the H-RIS. Further, the reflective coefficient and the transmissive coefficient for each meta-element at the H-RIS may be controlled by the same set of positive-intrinsic-negative (PIN) diodes. Therefore, the reflective coefficient and the transmissive coefficient may be correlated and quantized. In other words, it may sometimes be difficult or impossible for an H-RIS to determine the PIN diode states of all meta-elements to simultaneously generate a reflective beam and a transmissive beam.

According to various aspects, a network entity (e.g., a base station) may identify a meta-element coefficient association for a network node (e.g., an H-RIS). The network entity may transmit, for the network node, an indication of the meta-element coefficient association. The network node may identify a plurality of meta-element coefficients based on the meta-element coefficient association and at least one reference signal. The network node may forward a channel (e.g., a shared channel) from the network entity for a UE or from the UE for the network entity based on the plurality of meta-element coefficients and a one-sided operation or a two-sided operation. Accordingly, a protocol and signaling design to enable H-RIS based comminution may be provided. The protocol and signaling design may relate to the H-RIS capability report, the two-sided beam sweeping at the H-RIS, and/or the H-RIS meta-element coefficient association indication for the downlink and/or the uplink.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

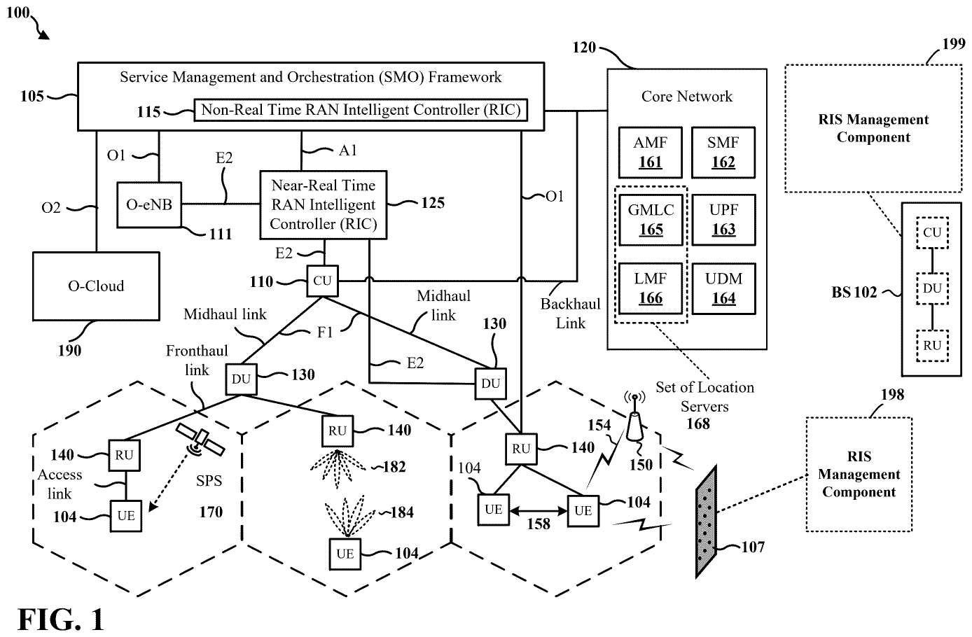

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the network node 107 (e.g., a RIS may have a RIS management component 198 that may be configured to receive an indication of a meta-element coefficient association from a network entity. The RIS management component 198 may be configured to identify a plurality of meta-element coefficients based on the meta-element coefficient association and at least one reference signal. The RIS management component 198 may be configured to forward a channel from the network entity for a UE or from the UE for the network entity based on the plurality of meta-element coefficients and a one-sided operation or a two-sided operation. In certain aspects, the base station 102 may have a RIS management component 199 that may be configured to identify a meta-element coefficient association for a network node. The RIS management component 199 may be configured to transmit, for the network node, an indication of the meta-element coefficient association. The RIS management component 199 may be configured to communicate with a UE via the network node based on a plurality of meta-element coefficients and a one-sided operation or a two-sided operation at the network node. The plurality of meta-element coefficients may be based on the meta-element coefficient association and at least one reference signal. A channel may be forwarded from the network entity for the UE or from the UE for the network entity via the network node based on the plurality of meta-element coefficients and the one-sided operation or the two-sided operation at the network node.

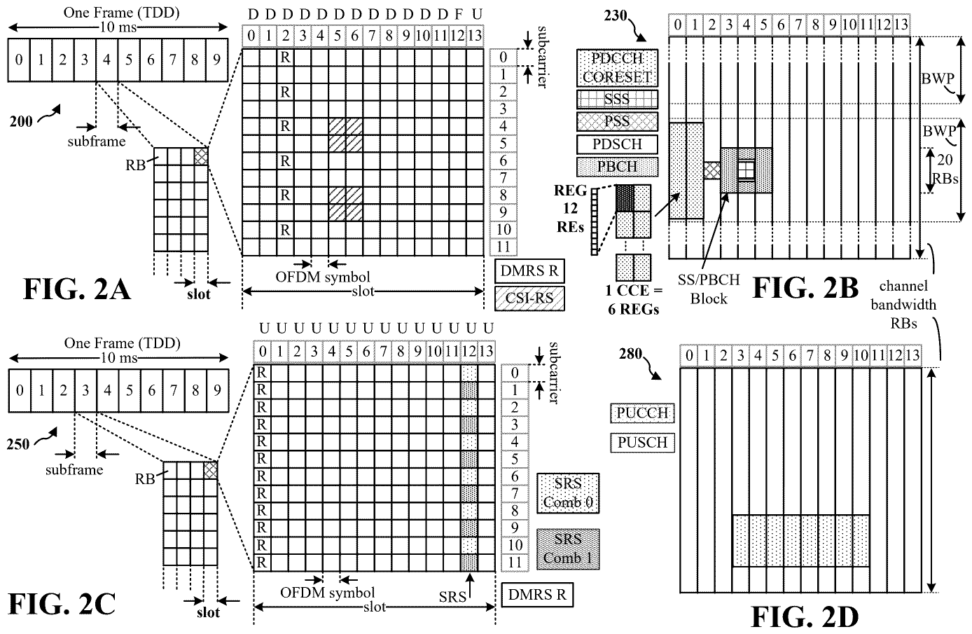

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2ª *15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

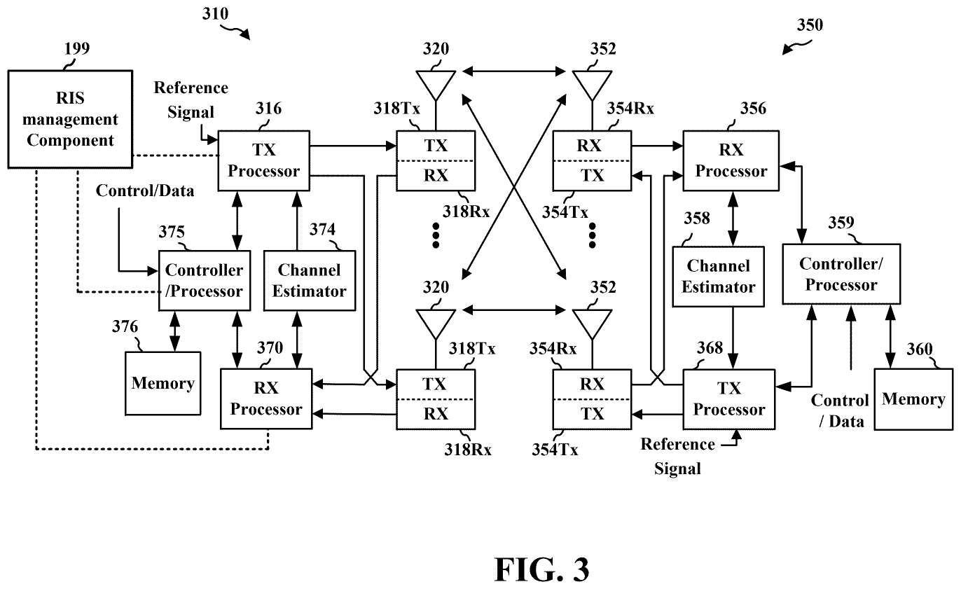

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the RIS management component 199 of FIG. 1.

In some configurations, a RIS may be a surface with a number of reconfigurable meta-elements that may reflect or refract electromagnetic waves to target directions. The number of reconfigurable meta-elements in a RIS may be large. Further, the reconfigurable meta-elements may be densely placed in the RIS.

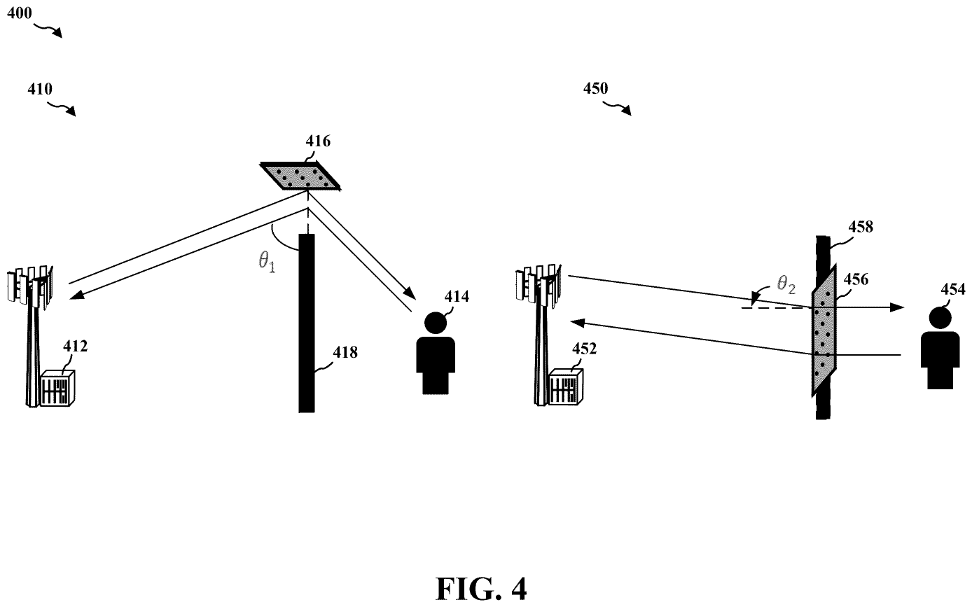

FIG. 4 is a diagram 400 illustrating the operation of example RISs. There may be a number of different types of RISs. For example, a RIS may be just reflective, just transmissive (refractive), or simultaneously transmissive and reflective. A simultaneously transmissive and reflective (STAR) RIS may be referred to as an H-RIS or an omni-RIS. As a RIS may include mainly PIN diodes or varactor diodes, and may consume just control power and not radiation power, the RIS may be a low cost and lower power solution for improving performance in a wireless communication system.

The diagram 410 illustrates the operation of an example reflective RIS 416. For a reflective RIS (e.g., the RIS 416), the transmitting device (e.g., a base station 412, a UE 414, or a radar) may be far away from the boresight direction of the RIS. In other words, the incident angle of the signal from the transmitting device (e.g., 01 as shown in the diagram 410 for the signal from the base station 412) may be much greater than zero (e.g., closer to 90 degrees). As shown, the reflective RIS 416 may help signals from the base station 412 or the UE 414 to propagate around the blockage 418 and reach the receiving device (e.g., the UE 414 or the base station 412, as the case may be). The diagram 450 illustrates the operation of a transmissive RIS 456 (also referred to as a refractive RIS). For a transmissive RIS (e.g., the RIS 456), the transmitting device (e.g., a base station 452, a UE 454, or a radar) may be within or near the boresight direction. In other words, the incident angle (e.g., 02 as shown in the diagram 450 for the signal from the base station 452) may be a small angle (e.g., slightly greater than or equal to zero). As shown, the transmissive RIS 456 may help signals from the base station 452 or the UE 454 to propagate around the blockage 458 and reach the receiving device (e.g., the UE 454 or the base station 452, as the case may be). In general, a transmissive RIS may have a higher meta-element radiation power than a reflective RIS. In one example configuration, a transmissive RIS may be equipped at a window. In some configurations, a transmissive RIS may include a surface split.

In different configurations, the RIS may be deployed at different positions. For example, the RIS may be deployed outdoors (e.g., on a building wall, on a traffic board, etc.). RISs deployed outdoors may be used for such example purposes as unmanned aerial vehicle (UAV) sensing, vehicle/pedestrian sensing, or outdoor-to-indoor sensing. In some additional examples, the RIS may be deployed indoors (e.g., on a room wall, on the ceiling, on a window, etc.). For example, RISs deployed indoors may be used for indoor sensing.

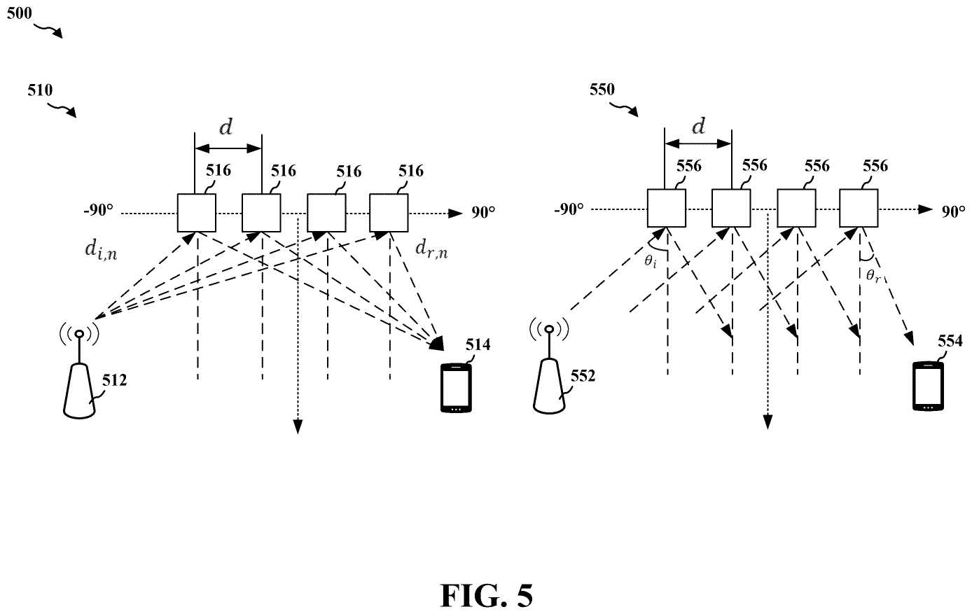

FIG. 5 is a diagram 500 illustrating reflective beamforming by a RIS. The diagram 510 illustrates a general model for reflective beamforming by the RIS. A transmitting device/base station 512, a receiving device/UE 514, and RIS elements 516 are shown in the diagram 510. According to the general model, for an incident angle {θ_{i,n}} and a reflection angle {θ_{r,n}}, the reflection gain by the RIS h may be calculated as:

$$h = {\sum }_{n = 0}^{N - 1} {e}^{j \frac{2 π ( ( {d}_{i , n} - {d}_{i , o} ) + ( {d}_{r , n} - {d}_{r , o} ) )}{λ}} \cdot {α}_{n} {e}^{j {ϕ}_{n}}$$

where αₙe^{jφ}^{ₙ} may be the reflective coefficient of the meta-element n.

The diagram 550 illustrates a far-field model for reflective beamforming by the RIS. A transmitting device/base station 552, a receiving device/UE 554, and RIS elements 556 are shown in the diagram 550. According to the far-field model, for an incident angle θᵢ and a reflection angle θᵣ, the reflection gain by the RIS h may be calculated as:

$$h = {\sum }_{n = 0}^{N - 1} {e}^{j \frac{2 π n d}{λ} ( {sin θ}_{i} + {sin θ}_{r} )} \cdot {α}_{n} {e}^{j {ϕ}_{n}}$$

where αₙe^{jφ}^{ₙ} may be the reflective coefficient of the meta-element n.

Optimally, αₙ≡α and

$${ϕ}_{n} = - \frac{2 π n d}{λ} ( sin {θ}_{i} + sin {θ}_{r} ) .$$

Practically, in some configurations, {αₙ, φₙ} may be derived from an enumerated set based on meta-element realization. An example set including phase shift and magnitude response configurations may be provided in the Table 2 below.

TABLE 2
Phase Shift and Magnitude Response Configurations

| Configuration | Phase Shift | Magnitude Response |
|---|---|---|
| 1 | −205.5° | −1.1 dB |
| 2 | −383.2° | −1.2 dB |
| 3 | −290.2° | −0.8 dB |
| 4 | −110.3° | −0.8 dB |

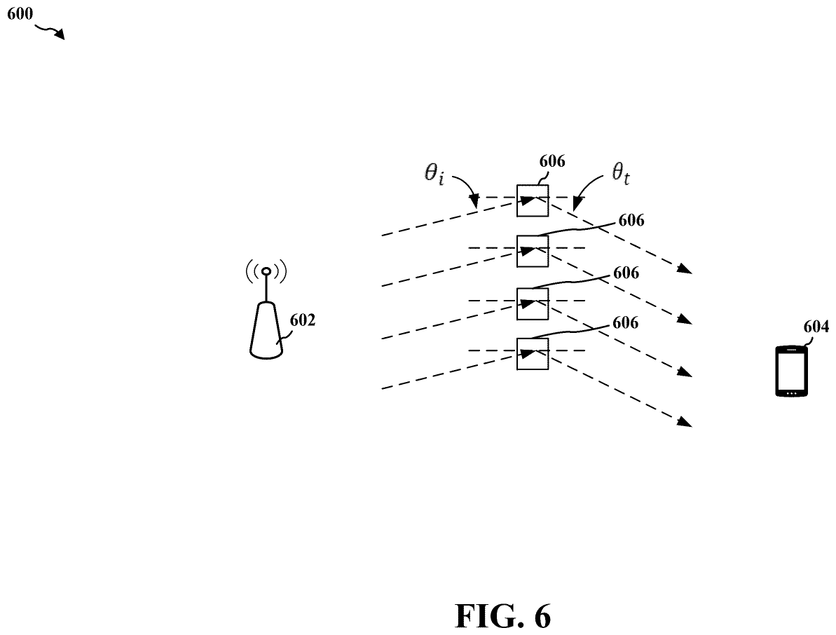

FIG. 6 is a diagram 600 illustrating beamforming by an example transmissive RIS in the far field. A transmitting device/base station 602, a receiving device/UE 604, and RIS elements 606 are shown in the diagram 600. It may be assumed that the transmitting device/base station/radar (e.g., transmitting device/base station 602) and the receiving device/target object (e.g., receiving device/UE 604) are both in the far field of the RIS. When a signal is transmitted toward the RIS at an incident angle θᵢ, the equivalent channel response value of the n-th element of the RIS at a transmissive angle θₜ may be

$${h}_{n} = {e}^{j \frac{2 π {d}_{n}}{λ} ( {sin θ}_{i} + {sin θ}_{t} )} \cdot {α}_{n} {e}^{j {θ}_{n ,}}$$

where αₙe^{jφ}^{ₙ} may be the reflection coefficient of the n-th RIS element, dₙ may be the distance between the n-th RIS element to the 1st RIS element, and A may be the signal wavelength.

Further, the overall equivalent channel response value of all the elements of the RIS at a transmissive angle θₜ may be

$$h = {Σ}_{n = 1}^{N} {h}_{n} = {Σ}_{n = 1}^{N} {e}^{j \frac{2 π {d}_{n}}{λ} ( {sin θ}_{i} + {sin θ}_{t} )} \cdot {α}_{n} {e}^{j {θ}_{n}} .$$

In theory, if the reflection coefficient satisfies αₙ≡α and

$${θ}_{n} = - \frac{2 π {d}_{n}}{λ} ( sin {θ}_{i} + sin {θ}_{t} ) ,$$

then the reflected beam may point to the direction Ot. In practice, however, the coefficient amplitude and phase values of each meta-element may be obtained from a limited set {(a₁, φ₁), (a₂, φ₂), . . . , (a_{M}, φ_{M})} associated with different configurations. Accordingly, in practice, the actual beam shape may deviate from the ideal beam. In general, the greater the number of RIS elements, the closer the actual beam shape may be to the ideal beam, and the more accurate the beam direction.

In some configurations, an H-RIS (also referred to as a STAR (RIS)) may implement simultaneous reflection and transmission (e.g., penetration, refraction) at each meta-element. Each meta-element may be in one of two possible states (also known as configurations). A meta-element may switch between the two possible states by switching on or off the PIN diodes associated with the meta-element. Accordingly, by appropriately setting states of the meta-elements, the H-RIS may generate the reflection beam and the transmission beam simultaneously. Table 3 below may provide example configurations associated with the two meta-element states.

TABLE 3
Configurations for Meta-Element States

| | PIN | PIN | Reflection coefficient | | | Transmission coefficient | | |
|---|---|---|---|---|---|---|---|---|
| State | diode-1 | diode-2 | Phase | Amplitude | Power | Phase | Amplitude | Power |
| 1 | OFF | OFF | 20° | 0.46 | 0.21 | 300° | 0.58 | 0.34 |
| 2 | ON | ON | 215° | 0.55 | 0.30 | 123° | 0.81 | 0.66 |

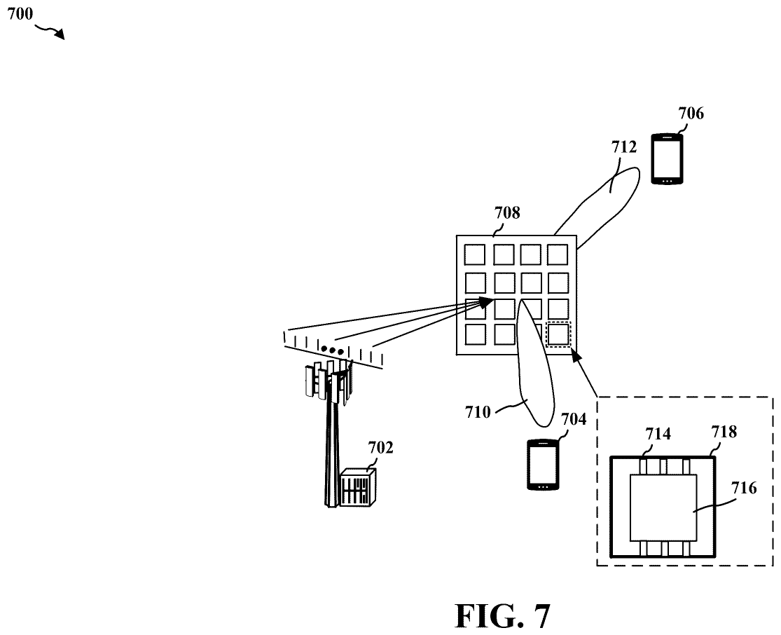

FIG. 7 is a diagram 700 illustrating the operation of an example H-RIS. As shown, a base station 702 may communicate, via an H-RIS 708 (also referred to as an intelligent omni-surface (IOS)), with a UE 704 on the reflection side of the H-RIS 708 and another UE 706 on the transmissive/refraction side of the H-RIS 708. In some configurations, the base station 702 may transmit signals toward the H-RIS 708 using a digital beamformer. In some configurations, based on the signals from the base station 602, the H-RIS 708 may generate a reflection beam 710 toward the UE 704 on the reflection side, and may generate a transmissive beam 712 toward the UE 706 on the transmissive side using the H-RIS based analog beamformer. In some configurations, each meta-element 718 may include a number of PIN diodes 714 and a refractive/reflective patch 716.

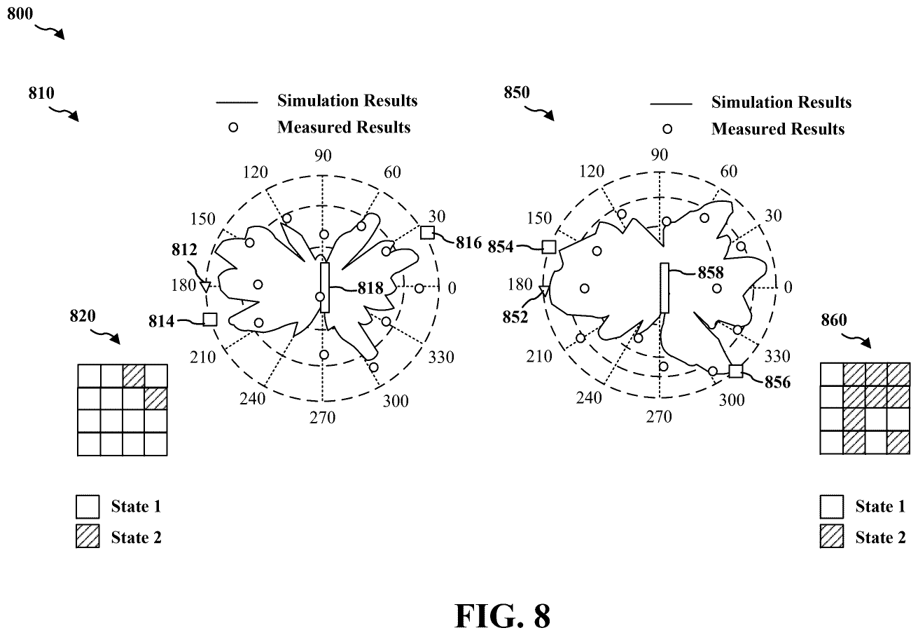

FIG. 8 is a diagram 800 illustrating radiation patterns of example H-RISs. Both the simulation results and the measured results are shown. The diagram 810 illustrates the radiation pattern of an example H-RIS 818 that may be operating based on a first H-RIS configuration 820 (which may correspond to certain meta-elements being in the first state and the other meta-elements being in the second state) and serving a base station 812, a UE 814 on the reflection side of the H-RIS 818, and another UE 816 on the transmissive side of the H-RIS 818. The diagram 850 illustrates the radiation pattern of an example H-RIS 858 that may be operating based on a second H-RIS configuration 860 and serving a base station 852, a UE 854 on the reflection side of the H-RIS 858, and another UE 856 on the transmissive side of the H-RIS 858.

The protocol and control signaling for efficient usage of an H-RIS in a wireless network may be useful. A RIS may work based on beamforming. To determine the optimal or suitable beam, a reflective RIS or a transmissive RIS may generate different meta-element coefficients to point the reflection beam or the transmissive beam, respectively, to different directions for the SSB and/or the CSI-RS. However, for the H-RIS, whether to perform a single-sided beam sweeping or a two-sided beam sweeping (beam sweeping may refer to a procedure where beams at different angles may be successively tested in order to find a suitable beam) may depend on the capability of the H-RIS. In some configurations, the network entity/base station may learn the capability of the H-RIS before the network entity/base station schedules radio resources for the RIS beam sweeping.

The reflective coefficient and the transmissive coefficient for each meta-element may be controlled by the same set of PIN diodes. Therefore, the reflective coefficient and the transmissive coefficient may be correlated and quantized. In other words, it may sometimes be difficult or impossible for an H-RIS to determine the PIN diode states of the meta-elements to simultaneously generate a reflective beam and a transmissive beam.

In addition, because the one-sided beams and the two-sided beams may overlap, to save radio resource, in some configurations, beam sweeping with the SSB or the CSI-RS may be performed based on either the one-sided beams (e.g., one-sided beam sweeping) or the two-sided beams (e.g., two-sided beam sweeping), but not both the one-sided beams and the two-sided beams. Thereafter, for data transmission (e.g., transmission via a PDSCH or a PUSCH), the beam type (e.g., reflective, transmissive, or both) may be identified based on the meta-element association relation indication provided to the H-RIS. In other words, the H-RIS may enter the one-sided operation mode after one-sided beam sweeping or two-sided beam sweeping, or may enter the two-sided operation mode after one-sided beam sweeping or two-sided beam sweeping.

In some configurations, the one-sided data transmission may be associated with a one-sided reference signal or a two-sided reference signal. In some configurations, the two-sided data transmission may be associated with two one-sided reference signals or one two-sided reference signal. In some configurations, a network entity/base station may provide the configuration information to the H-RIS, so that the H-RIS may generate the correct beams.

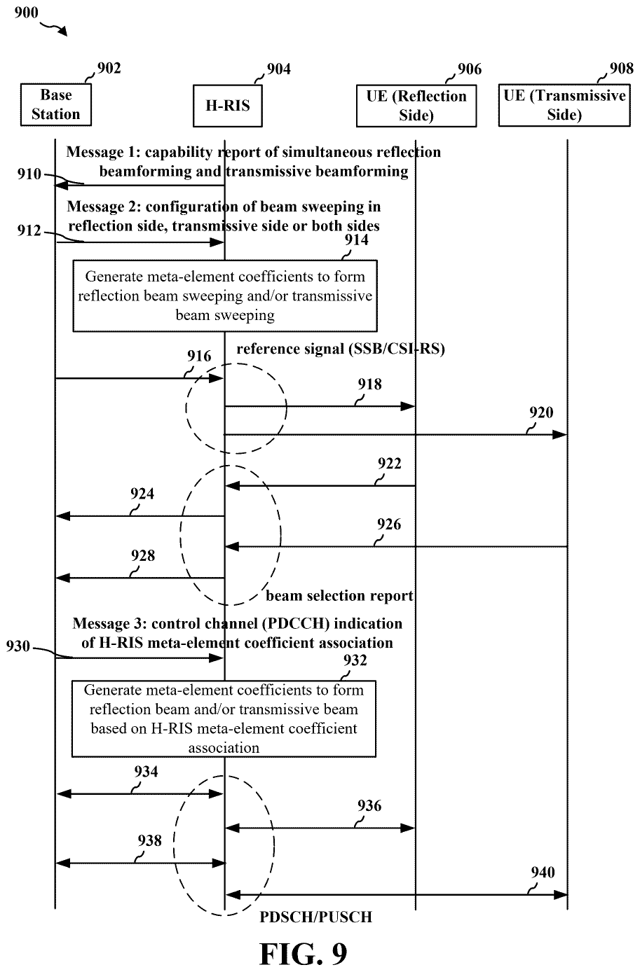

FIG. 9 is a diagram of a communication flow 900 of a method of wireless communication. The base station 902 may implement aspects of the base station 702/812/852. The H-RIS 904 may implement aspects of the H-RIS 708. The UE 906 may implement aspects of the UE 704/814/854. Further, the UE 908 may implement aspects of the UE 706/816/856. At 910, the H-RIS 904 may transmit, for the base station 902, a capability report for the capability of the H-RIS 904 associated with simultaneous reflection beamforming and transmissive beamforming.

In some configurations, the H-RIS 904 may also report, to the base station 902, whether the H-RIS 904 may be capable of mitigating interference on the other side when the H-RIS 904 reflects/transmits just on one side.

At 912, the base station 902 may transmit, for the H-RIS 904, a beam sweeping configuration associated with one of a one-sided beam sweeping at the reflection side, a one-sided beam sweeping at the transmissive side, or a two-sided beam sweeping at both the reflection side and the transmissive side.

In some configurations, if a one-sided beam sweeping (i.e., reflection side beam sweeping or transmissive side beam sweeping, but not beam sweeping on both sides simultaneously) is to be performed at the H-RIS 904, the base station 902 may also indicate, to the H-RIS 904, whether to mitigate interference on the other side (assuming the H-RIS 904 is capable of such interference mitigation).

At 914, the H-RIS 904 may generate meta-element coefficients for reflection side beam sweeping and/or transmissive side beam sweeping.

At 916 and 918, if reflection side beam sweeping is to be performed based on the beam sweeping configuration at 912, the base station 902 may transmit, for the UE 906, a reference signal via the H-RIS 904, where the H-RIS 904 may sweep reference signal beams at the reflection side. The reference signal may be an SSB or a CSI-RS. At 916 and 920, if transmissive side beam sweeping is to be performed based on the beam sweeping configuration at 912, the base station 902 may transmit, for the UE 908, a reference signal via the H-RIS 904, where the H-RIS 904 may sweep reference signal beams at the transmissive side. The reference signal may be an SSB or a CSI-RS.

At 922 and 924, if reflection side beam sweeping is performed, the UE 906 may transmit, for the base station 902, a beam selection report via the H-RIS 904, where the beam selection report may be based on beam measurement results at the UE 906 obtained during the reflection side beam sweeping. The beam selection report may indicate at least one suitable reflection side beam.

At 926 and 928, if transmissive side beam sweeping is performed, the UE 908 may transmit, for the base station 902, a beam selection report via the H-RIS 904, where the beam selection report may be based on beam measurement results at the UE 908 obtained during the transmissive side beam sweeping. The beam selection report may indicate at least one suitable transmissive side beam.

At 930, the base station 902 may transmit, for the H-RIS 904, an indication of H-RIS meta-element coefficient association. In one configuration, the base station 902 may transit the indication at 930 via a control channel (e.g., a PDCCH). The indication of the H-RIS meta-element coefficient association may refer to an indication of the association between the reflection/transmissive beam(s) for the PDSCH/PUSCH (e.g., for data communication) and the reference signal beams (e.g., SSB beams or CSI-RS beams) at 918/920.

In some configurations, if the reference signal beams at 918/920 are one-sided but the PDSCH/PUSCH is two-sided, the indication of the H-RIS meta-element coefficient association at 930 may further indicate two reference signal beams for the reflection beam and the transmissive beam, where one of the two reference signal beams may be associated with the reflection beam and the other of the two reference signal beams may be associated with the transmissive beam.

In some configurations, if the reference signal beams at 918/920 are two-sided but the PDSCH/PUSCH is one-sided, the indication of the H-RIS meta-element coefficient association at 930 may further indicate the side (i.e., reflection or transmissive) to be used for the PDSCH/PUSCH and whether interference mitigation is to be activated on the other side (assuming the H-RIS 904 is capable of such interference mitigation).

At 932, the H-RIS 904 may calculate (generate) meta-element coefficients based on the H-RIS meta-element coefficient association to generate the reflection beam and/or the transmissive beam.

At 934 and 936, if reflection side communication is enabled at the H-RIS 904, the base station 902 and the UE 906 may communicate with each other (e.g., transmit and receive PDSCHs/PUSCHs) via the H-RIS 904.

At 938 and 940, if transmissive side communication is enabled at the H-RIS 904, the base station 902 and the UE 908 may communicate with each other (e.g., transmit and receive PDSCHs/PUSCHs) via the H-RIS 904.

As described above, based on determining the reflection/transmissive beamforming coefficient, an H-RIS may generate a reflection beam or a transmissive beam for 1) a given incident angle θᵢ and 2) a reflective angle θᵣ or a transmissive angle θₜ. However, the capability of an H-RIS to simultaneously generate a reflection beam and a transmissive beam for a given triplet {θᵢ, θᵣ, θₜ} may depend on the processing and storage capability of the H-RIS. In particular, calculating meta-element coefficients for simultaneous reflection beam and transmission beam may involve a singular value decomposition (SVD) (or eigenvalue decomposition (EVD)) operation, which will be described in further detail below. In some configurations, the quantity of triplets {θᵢ, θᵣ, θₜ} may be large. Accordingly, a high processing capability (e.g., for real-time calculation) and/or a high storage capability (e.g., for in-advance calculation) may be needed for the calculations.

Accordingly, some less capable H-RISs may not support simultaneous reflection beam and transmissive beam, that is, the less capable H-RISs may support just non-simultaneous reflection beam and transmissive beam. Accordingly, for example, at 910, the H-RIS 904 may report to the base station 902, whether the H-RIS 904 supports simultaneous reflection beam and transmissive beam. Furthermore, in some configurations, an H-RIS (e.g., the H-RIS 904) may also report whether the H-RIS is capable of mitigating interference on the other side when the H-RIS reflects/refracts signals on just one side (i.e., when the H-RIS is in a one-sided operation mode). In particular, in some configurations, the interference mitigation may be of a “zero signal power” type, or a “minimization of the maximum signal power in various (all) directions” type, or any other suitable type.

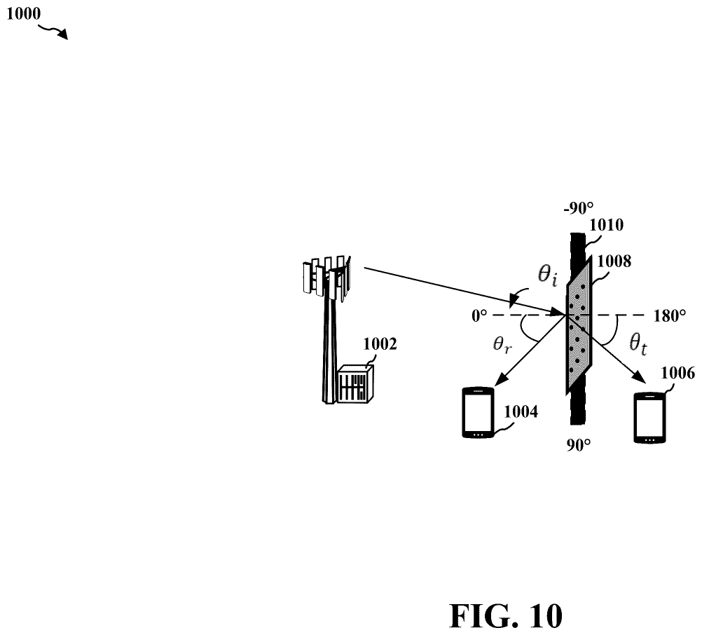

FIG. 10 is a diagram 1000 illustrating an incident angle θᵢ, a reflective angle θᵣ, and a transmissive angle θₜ associated with an example H-RIS. As shown, a base station 1002 may transmit signals, via an H-RIS 1008, to a UE 1004 at the reflection side of the H-RIS 1008 and to another UE 1006 at the transmissive side of the H-RIS 1008. Due to the presence of the H-RIS 1008, the base station 1002 may be able to communicate with the UE 1004 and the UE 1006 despite the presence of blockages (e.g., blockage 1010). As described above, an H-RIS (e.g., the H-RIS 1008) may calculate meta-element coefficients for simultaneous reflection beam and transmissive beam. In particular, for a triplet {θᵢ, θᵣ, θₜ}, the RIS may perform the calculation as follows, where N may be the number of meta-elements in one dimension (for simplicity, the single dimension is used here as an example).

The reflection steering vector may be

$$a = {[ 1 , {e}^{j \frac{2 π d}{λ} ( {sin θ}_{i} + {sin θ}_{r} )} , … , {e}^{j \frac{2 π ( N - 1 ) d}{λ} ( sin {θ}_{i} + {sin θ}_{r} )} ]}^{T} .$$

Further, the transmissive steering vector may be

$$b = {[ 1 , {e}^{j \frac{2 π d}{λ} ( {sin θ}_{i} + {sin θ}_{t} )} , … , {e}^{j \frac{2 π ( N - 1 ) d}{λ} ( {sin θ}_{i} + {sin θ}_{t} )} ]}^{T} .$$

Next, to generate simultaneous reflection beam and transmissive beam, the (optimal) reflection coefficient vector w and the (optimal) transmissive coefficient vector wₜ may satisfy

$$\{ {\hat{w}}_{r} , {\hat{w}}_{t} \} = arg {max}_{{w}_{r} , {w}_{t}} ( {\vert {a}^{H} {w}_{r} \vert}^{2} + {\vert {b}^{H} {w}_{t} \vert}^{2} ) .$$

As the values in wᵣ and wₜ may be controlled by the same PIN diodes of one meta-element, the values in wᵣ and wₜ may be correlated. For example, referring to Table 3 above, for a certain meta-element, w_{t,n}≈w_{r,n}e^{jφ}. Then, the optimization may become

$$\{ {\hat{w}}_{r} \} = arg {max}_{{w}_{r}} ( {\vert {a}^{H} {w}_{r} \vert}^{2} + {\vert {c}^{H} {w}_{r} \vert}^{2} ) ,$$

where c=e^{jφ}b. Because

$${\vert {a}^{H} {w}_{r} \vert}^{2} + {\vert {c}^{H} {w}_{r} \vert}^{2} = {w}_{r}^{H} {aa}^{H} {w}_{r} + {w}_{r}^{H} {cc}^{H} {w}_{r} = {w}_{r}^{H} ( {aa}^{H} + {cc}^{H} ) {w}_{r} , {\hat{w}}_{r}$$

may be the major eigenvector of the matrix aa^{H}+cc^{H}.

Further, the values of wᵣ may be implemented by PIN diodes or varactor diodes of each meta-element. If the value of each meta-element coefficient is quantized with 2 bits, then the phases of candidate reflection coefficient values may be Φᵣ=[0°, 90°, 180°, 270°]. If q=45°, then the phases of candidate reflection coefficient values may be Φₜ=[45°, 135°, 225°, 315°]. In this case, each value in ŵᵣ may be quantized as one value in Φᵣ, and the corresponding value in ŵₜ may be quantized as the corresponding value in Φₜ.

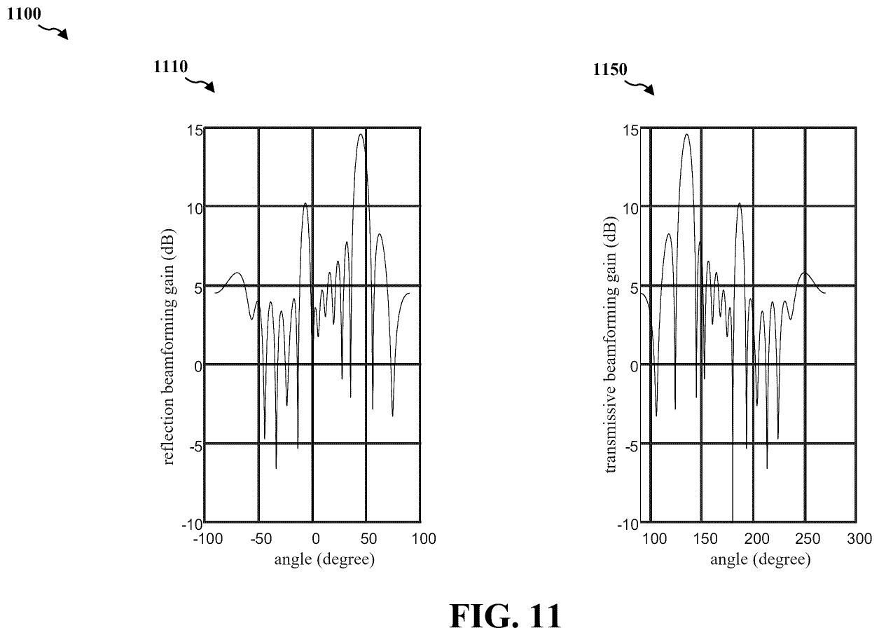

FIG. 11 is a diagram 1100 illustrating the beamforming gain associated with an example H-RIS. The diagram 1110 may illustrate the reflection beamforming gain as a function of the reflection angle. As shown in this example, the peak reflection beamforming gain may be achieved when the reflection angle is around 40°. The diagram 1150 may illustrate the transmissive beamforming gain as a function of the transmissive angle. As shown in this example, the peak transmissive beamforming gain may be achieved when the transmissive angle is around 130°.

In different configurations, the network entity/base station may configure a beam sweeping mode (e.g., at 912) for the H-RIS, where the beam sweeping mode may be selected from a number of usable beam sweeping modes. For example, in a first mode, based on the configuration, the H-RIS may perform just reflection beam sweeping (i.e., one-sided beam sweeping at just the reflection side) (without interference mitigation). In a second example mode, based on the configuration, the H-RIS may perform just transmissive beam sweeping (i.e., one-sided beam sweeping at just the transmissive side) (without interference mitigation). In a third example mode, based on the configuration, the H-RIS may perform simultaneous reflection beam sweeping and transmissive beam sweeping (i.e., two-sided beam sweeping). The two-sided beam sweeping may reduce radio resource consumption and improve the efficiency in the use of the radio resource. In a fourth example mode, based on the configuration, the H-RIS may perform just reflection beam sweeping (i.e., one-sided beam sweeping at just the reflection side) with interference mitigation at the transmissive side. The interference reduction or elimination at the transmissive side may improve other communications on the transmissive side of the H-RIS (e.g., between a UE on the transmissive side of the H-RIS and another base station or another RIS). In a fifth example mode, based on the configuration, the H-RIS may perform just transmissive beam sweeping (i.e., one-sided beam sweeping at just the transmissive side) with interference mitigation at the reflection side. The interference reduction or elimination at the reflection side may improve other communications on the reflection side of the H-RIS (e.g., between a UE on the reflection side of the H-RIS and another base station or another RIS).

In one or more configurations, for a selected beam sweeping mode, the network entity/base station may configure an incident angle, a range of reflection angles and/or a range of transmissive angles, as appropriate.

In one or more configurations, based on the configured beam sweeping mode, as described above, the H-RIS may calculate the meta-element coefficients for each pair {θᵢ, θ_{r,k}}, {θᵢ, θ_{t,k}} or each triplet {θᵢ, θ_{r,k}_{₁}, θ_{t,k}_{₂}}, as appropriate, where k, k₁, k₂ may denote one angle in the angle range swept by the beams. Further, in some configurations, with interference mitigation, the H-RIS may reduce or eliminate the signal power on the other side when the H-RIS reflects/refracts signals on one side. For example, an H-RIS may eliminate the signal power on the other side, e.g., based on a metallic (e.g., copper) plane included at the transmissive side. In another example, an H-RIS may calculate a vector of special meta-element coefficients such that the maximum signal power at various (e.g., all) reflection/transmissive direction angles on the other side is minimized.

In some configurations, at 930, the base station 902 may indicate an H-RIS meta-element coefficient association for a downlink data transmission. If the reference signal beams at 918/920 are one-sided but the PDSCH is two-sided, the indication of the H-RIS meta-element coefficient association may further indicate two reference signal beams for the reflection beam for the PDSCH and the transmissive beam for the PDSCH, where one of the two reference signal beams may be associated with the reflection beam for the PDSCH and the other of the two reference signal beams may be associated with the transmissive beam for the PDSCH.

For example, the base station may first configure the H-RIS with beam sweeping based on the first example mode or the fourth example mode described above in the CSI-RS resource set 1 and beam sweeping based on the second example mode or the fifth example mode described above in the CSI-RS resource set 2. Then the base station may send a two-sided downlink data transmission grant to the H-RIS, indicating the meta-element coefficient association for the PDSCH may be associated with two CSI-RS resources of CSI-RS resource sets 1 and 2, jointly.

Accordingly, in the PDSCH resource, the H-RIS may calculate (generate) the meta-element coefficients based on the reflection beam and the transmissive beam in the corresponding CSI-RS resources.

If the reference signal beams at 918/920 are two-sided but the PDSCH is one-sided, the indication of the H-RIS meta-element coefficient association may further indicate the side of the H-RIS to be used for the PDSCH and whether interference mitigation on the other side is to be activated (assuming the H-RIS is capable of such interference mitigation).

For example, the base station may first configure the H-RIS with beam sweeping based on the third example mode described above in the CSI-RS resource set 1. Then the base station may send a one-sided downlink data transmission grant to the H-RIS, indicating that the meta-element coefficient association for the PDSCH is associated with a CSI-RS resource in the CSI-RS resource set 1. The one-sided downlink data transmission grant may also indicate the side of the H-RIS to be used for the PDSCH (an aiming direction) and whether interference mitigation on the other side is to be activated (assuming the H-RIS is capable of such interference mitigation).

Accordingly, in the PDSCH resource, the H-RIS may calculate (generate) the meta-element coefficients based on the reflection beam or the transmissive beam in the corresponding CSI-RS resource. Further, the H-RIS may or may not activate interference mitigation on the other side, depending on the indication from the base station.

In some configurations, at 930, the base station 902 may indicate an H-RIS meta-element coefficient association for an uplink data transmission. For the uplink transmission, the base station may indicate, to the H-RIS, an H-RIS meta-element coefficient association similar to one for a downlink transmission as described above.

If the reference signal beams at 918/920 are one-sided but the PUSCH is two-sided, the indication of the H-RIS meta-element coefficient association may further indicate two reference signal beams for the reflection beam for the PUSCH and the transmissive beam for the PUSCH, where one of the two reference signal beams may be associated with the reflection beam for the PUSCH and the other of the two reference signal beams may be associated with the transmissive beam for the PUSCH.

For example, the base station may first configure the H-RIS with beam sweeping based on the first example mode or the fourth example mode described above in the CSI-RS resource set 1 and beam sweeping based on the second example mode or the fifth example mode described above in the CSI-RS resource set 2. Then the base station may send a two-sided uplink data transmission grant to the H-RIS, indicating the meta-element coefficient association for the PUSCH may be associated with two CSI-RS resources of CSI-RS resource sets 1 and 2, jointly.

Accordingly, in the PUSCH resource, the H-RIS may calculate (generate) the meta-element coefficients based on the reflection beam and the transmissive beam in the corresponding CSI-RS resources.

If the reference signal beams at 918/920 are two-sided but the PUSCH is one-sided, the indication of the H-RIS meta-element coefficient association may further indicate the side of the H-RIS to be used for the PUSCH and whether interference mitigation on the other side is to be activated (assuming the H-RIS is capable of such interference mitigation).

For example, the base station may first configure the H-RIS with beam sweeping based on the third example mode described above in the CSI-RS resource set 1. Then the base station may send a one-sided uplink data transmission grant to the H-RIS, indicating that the meta-element coefficient association for the PUSCH is associated with a CSI-RS resource in the CSI-RS resource set 1. The one-sided uplink data transmission grant may also indicate the side of the H-RIS to be used for the PUSCH (an aiming direction) and whether interference mitigation on the other side is to be activated (assuming the H-RIS is capable of such interference mitigation) (the interference mitigation may be available on just the reflection side).

Accordingly, in the PUSCH resource, the H-RIS may calculate (generate) the meta-element coefficients based on the reflection beam or the transmissive beam in the corresponding CSI-RS resource. Further, the H-RIS may or may not activate interference mitigation on the other side, depending on the indication from the base station.

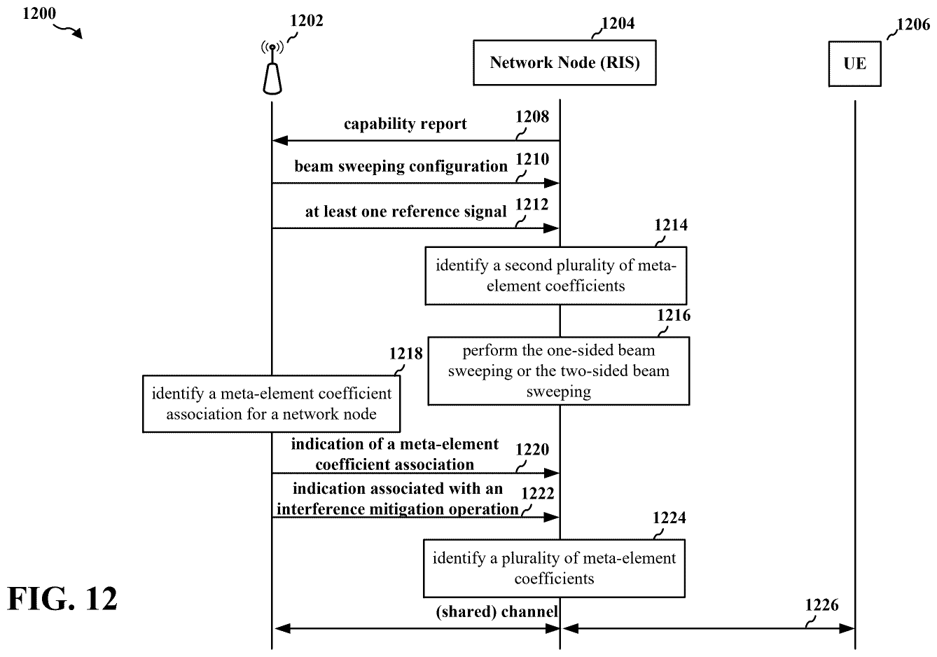

FIG. 12 a diagram of a communication flow 1200 of a method of wireless communication. The network entity 1202 may implement aspects of the base station 102/310/412/452/512/552/602/702/812/852/902/1002. The network node 1204 may implement aspects of the RIS (e.g., H-RIS) 107/416/456/708/904/1008. The UE 1206 may implement aspects of the UE 104/350/414/454/514/554/604/704/706/814/816/854/856/906/908/1004/1006. IN one or more configurations, at 1208, the network node 1204 may transmit, for the network entity 1202, a capability report associated with at least one of the one-sided operation or the two-sided operation (at the network node 1204). Therefore, in one configuration, at 1208, the network node 1204 may transmit, for the network entity 1202, a capability report associated with the one-sided operation (at the network node 1204). In another configuration, at 1208, the network node 1204 may transmit, for the network entity 1202, a capability report associated with the two-sided operation (at the network node 1204).

In one configuration, the capability report at 1208 may include an indication of an interference mitigation capability (at the network node 1204) associated with the one-sided operation.

In one or more configurations, at 1210, the network entity 1202 may transmit, for the network node 1204, a beam sweeping configuration based on the capability report at 1208. The beam sweeping configuration may be associated with one-sided beam sweeping or two-sided beam sweeping. Therefore, in one configuration, the beam sweeping configuration may be associated with one-sided beam sweeping. In another configuration, the beam sweeping configuration may be associated with two-sided beam sweeping.

In one configuration, the beam sweeping configuration at 1210 may be associated with the one-sided beam sweeping. The beam sweeping configuration may include an indication associated with an interference mitigation operation based on the interference mitigation capability.

In one or more configurations, the beam sweeping configuration at 1210 may include one or more indications of at least one of an incident angle, a range of reflection angles, or a range of transmissive angles.

In one or more configurations, at 1212, the network entity 1202 may transmit, for the network node 1204, the at least one reference signal. The one-sided beam sweeping or the two-sided beam sweeping may be based on the beam sweeping configuration and the at least one reference signal. In one configuration, the one-sided beam sweeping may be based on the beam sweeping configuration and the at least one reference signal. In another configuration, the two-sided beam sweeping may be based on the beam sweeping configuration and the at least one reference signal.

In one or more configurations, the at least one reference signal at 1212 may include at least one of a CSI-RS or an SSB.

In one or more configurations, at 1214, the network node 1204 may identify a second plurality of meta-element coefficients for the one-sided beam sweeping or the two-sided beam sweeping based on the beam sweeping configuration at 1210. The one-sided beam sweeping or the two-sided beam sweeping may be performed based further on the second plurality of meta-element coefficients. Therefore, in one configuration, at 1214, the network node 1204 may identify a second plurality of meta-element coefficients for the one-sided beam sweeping based on the beam sweeping configuration at 1210. The one-sided beam sweeping may be performed based further on the second plurality of meta-element coefficients. In another configuration, at 1214, the network node 1204 may identify a second plurality of meta-element coefficients for the two-sided beam sweeping based on the beam sweeping configuration at 1210. The two-sided beam sweeping may be performed based further on the second plurality of meta-element coefficients.

In one or more configurations, at 1216, the network node 1204 may perform the one-sided beam sweeping or the two-sided beam sweeping based on the beam sweeping configuration at 1210 and the at least one reference signal at 1212. Therefore, in one configuration, the network node 1204 may perform the one-sided beam sweeping based on the beam sweeping configuration at 1210 and the at least one reference signal at 1212. In another configuration, the network node 1204 may perform the two-sided beam sweeping based on the beam sweeping configuration at 1210 and the at least one reference signal at 1212.

At 1218, the network entity 1202 may identify a meta-element coefficient association for the network node 1204.

At 1220, the network entity 1202 may transmit, for the network node 1204, an indication of the meta-element coefficient association.

In one configuration, at 1222, the network entity 1202 may transmit, for the network node 1204, an indication associated with an interference mitigation operation at the network node 1204.

At 1224, the network node 1204 may identify a plurality of meta-element coefficients based on the meta-element coefficient association and at least one reference signal.

At 1226, the network node 1204 may forward a channel (e.g., a shared channel) from the network entity 1202 for a UE 1206 or from the UE 1206 for the network entity 1202 based on the plurality of meta-element coefficients and a one-sided operation or a two-sided operation.

In one configuration, the channel may be forwarded, at 1226, based on the one-sided operation. The channel may be forwarded, at 1226, based on one of reflection or refraction at the network node 1204.

In one configuration, the at least one reference signal at 1212 may be associated with two sides of the network node 1204. The indication of the meta-element coefficient association at 1220 may further include an indication of a single side of the network node 1204 associated with the one-sided operation.

In one configuration, the channel may be forwarded, at 1226, based on the two-sided operation. The channel may be forwarded, at 1226, based on both of reflection and refraction at the network node 1204.

In one configuration, the at least one reference signal at 1212 may include a single reference signal associated with two sides of the network node 1204. The indication of the meta-element coefficient association at 1220 may further include an indication of the single reference signal.

In one configuration, the at least one reference signal at 1212 may include two reference signals each associated with one of two sides of the network node 1204. The indication of the meta-element coefficient association at 1220 may further include an indication of the two reference signals.

In one or more configurations, the channel at 1226 may include a PDSCH or a PUSCH.

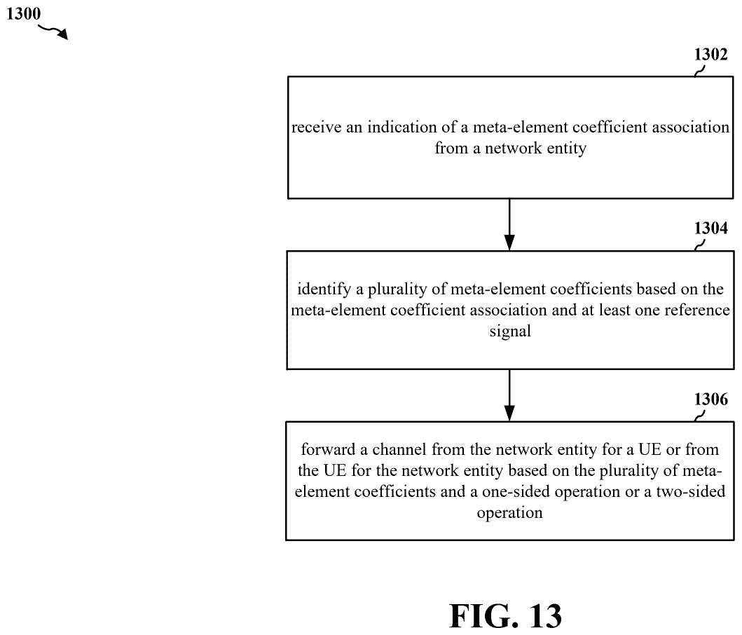

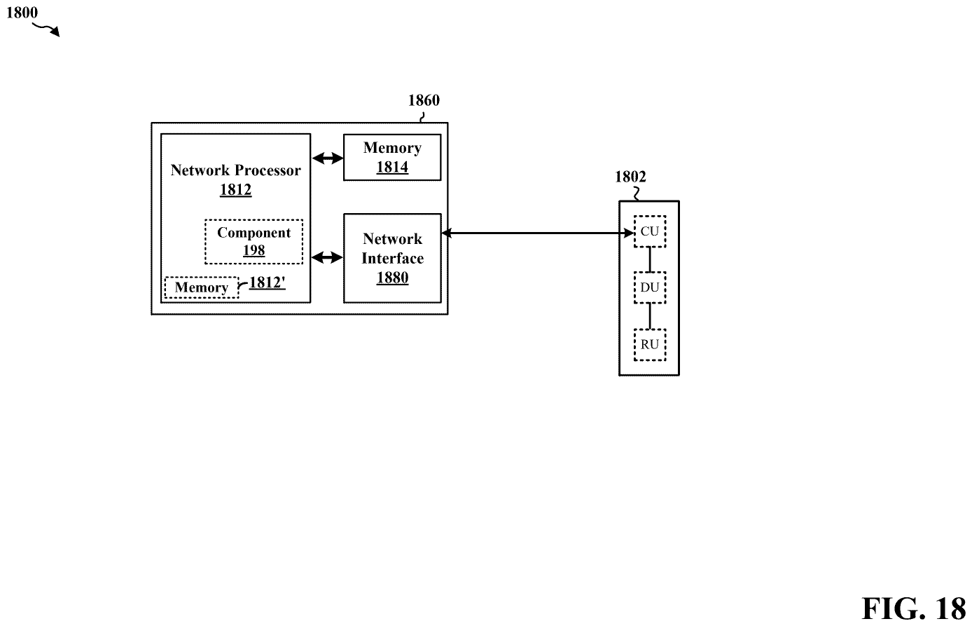

FIG. 13 is a flowchart 1300 of a method of wireless communication. The method may be performed by a network node (e.g., the network node 107/1204; the RIS 416/456/708/904/1008; the apparatus 1860). At 1302, the network node may receive an indication of a meta-element coefficient association from a network entity. For example, 1302 may be performed by the component 198 in FIG. 18. Referring to FIG. 12, at 1220, the network node 1204 may receive an indication of a meta-element coefficient association from a network entity 1202.

At 1304, the network node may identify a plurality of meta-element coefficients based on the meta-element coefficient association and at least one reference signal. For example, 1304 may be performed by the component 198 in FIG. 18. Referring to FIG. 12, at 1224, the network node 1204 may identify a plurality of meta-element coefficients based on the meta-element coefficient association and at least one reference signal.

At 1306, the network node may forward a channel from the network entity for a UE or from the UE for the network entity based on the plurality of meta-element coefficients and a one-sided operation or a two-sided operation. For example, 1306 may be performed by the component 198 in FIG. 18. Referring to FIG. 12, at 1226, the network node 1204 may forward a channel from the network entity 1202 for a UE 1206 or from the UE 1206 for the network entity 1202 based on the plurality of meta-element coefficients and a one-sided operation or a two-sided operation.

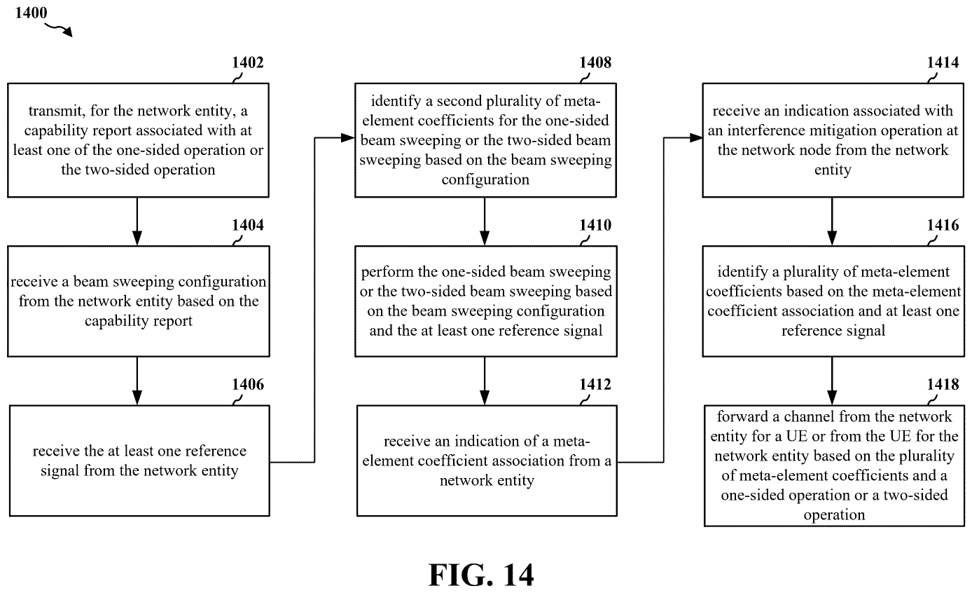

FIG. 14 is a flowchart 1400 of a method of wireless communication. The method may be performed by a network node (e.g., the network node 107/1204; the RIS 416/456/708/904/1008; the apparatus 1860). At 1412, the network node may receive an indication of a meta-element coefficient association from a network entity. For example, 1412 may be performed by the component 198 in FIG. 18. Referring to FIG. 12, at 1220, the network node 1204 may receive an indication of a meta-element coefficient association from a network entity 1202.

At 1416, the network node may identify a plurality of meta-element coefficients based on the meta-element coefficient association and at least one reference signal. For example, 1416 may be performed by the component 198 in FIG. 18. Referring to FIG. 12, at 1224, the network node 1204 may identify a plurality of meta-element coefficients based on the meta-element coefficient association and at least one reference signal.

At 1418, the network node may forward a channel from the network entity for a UE or from the UE for the network entity based on the plurality of meta-element coefficients and a one-sided operation or a two-sided operation. For example, 1418 may be performed by the component 198 in FIG. 18. Referring to FIG. 12, at 1226, the network node 1204 may forward a channel from the network entity 1202 for a UE 1206 or from the UE 1206 for the network entity 1202 based on the plurality of meta-element coefficients and a one-sided operation or a two-sided operation.

In one configuration, referring to FIG. 12, the channel may be forwarded, at 1226, based on the one-sided operation. The channel may be forwarded, at 1226, based on one of reflection or refraction at the network node 1204.

In one configuration, referring to FIG. 12, the at least one reference signal at 1212 may be associated with two sides of the network node 1204. The indication of the meta-element coefficient association at 1220 may further include an indication of a single side of the network node 1204 associated with the one-sided operation.

In one configuration, at 1414, the network node may receive an indication associated with an interference mitigation operation at the network node from the network entity. For example, 1414 may be performed by the component 198 in FIG. 18. Referring to FIG. 12, at 1222, the network node 1204 may receive an indication associated with an interference mitigation operation at the network node 1204 from the network entity 1202.

In one configuration, referring to FIG. 12, the channel may be forwarded, at 1226, based on the two-sided operation. The channel may be forwarded, at 1226, based on both of reflection and refraction at the network node 1204.

In one configuration, referring to FIG. 12, the at least one reference signal at 1212 may include a single reference signal associated with two sides of the network node 1204. The indication of the meta-element coefficient association at 1220 may further include an indication of the single reference signal.

In one configuration, referring to FIG. 12, the at least one reference signal at 1212 may include two reference signals each associated with one of two sides of the network node 1204. The indication of the meta-element coefficient association at 1222 may further include an indication of the two reference signals.

In one configuration, at 1402, the network node may transmit, for the network entity, a capability report associated with at least one of the one-sided operation or the two-sided operation. For example, 1402 may be performed by the component 198 in FIG. 18. Referring to FIG. 12, at 1208, the network node 1204 may transmit, for the network entity 1202, a capability report associated with at least one of the one-sided operation or the two-sided operation. Therefore, in one configuration, the network node may transmit, for the network entity, a capability report associated with the one-sided operation. In another configuration, the network node may transmit, for the network entity, a capability report associated with the two-sided operation.

At 1404, the network node may receive a beam sweeping configuration from the network entity based on the capability report. The beam sweeping configuration may be associated with one-sided beam sweeping or two-sided beam sweeping. For example, 1404 may be performed by the component 198 in FIG. 18. Referring to FIG. 12, at 1210, the network node 1204 may receive a beam sweeping configuration from the network entity 1202 based on the capability report at 1208. Therefore, in one configuration, the beam sweeping configuration may be associated with one-sided beam sweeping. In another configuration, the beam sweeping configuration may be associated with two-sided beam sweeping.

At 1406, the network node may receive the at least one reference signal from the network entity. For example, 1406 may be performed by the component 198 in FIG. 18. Referring to FIG. 12, at 1212, the network node 1204 may receive the at least one reference signal from the network entity 1202.

At 1410, the network node may perform the one-sided beam sweeping or the two-sided beam sweeping based on the beam sweeping configuration and the at least one reference signal. For example, 1410 may be performed by the component 198 in FIG. 18. Referring to FIG. 12, at 1216, the network node 1204 may perform the one-sided beam sweeping or the two-sided beam sweeping based on the beam sweeping configuration at 1210 and the at least one reference signal at 1212. Therefore, in one configuration, the network node may perform the one-sided beam sweeping based on the beam sweeping configuration and the at least one reference signal. In another configuration, the network node may perform the two-sided beam sweeping based on the beam sweeping configuration and the at least one reference signal.

In one configuration, referring to FIG. 12, the capability report at 1208 may include an indication of an interference mitigation capability associated with the one-sided operation.

In one configuration, referring to FIG. 12, the beam sweeping configuration at 1210 may be associated with the one-sided beam sweeping. The beam sweeping configuration at 1210 may include an indication associated with an interference mitigation operation based on the interference mitigation capability.

In one configuration, at 1408, the network node may identify a second plurality of meta-element coefficients for the one-sided beam sweeping or the two-sided beam sweeping based on the beam sweeping configuration. The one-sided beam sweeping or the two-sided beam sweeping may be performed based further on the second plurality of meta-element coefficients. For example, 1408 may be performed by the component 198 in FIG. 18. Referring to FIG. 12, at 1214, the network node 1204 may identify a second plurality of meta-element coefficients for the one-sided beam sweeping or the two-sided beam sweeping based on the beam sweeping configuration at 1210. Therefore, in one configuration, the network node may identify a second plurality of meta-element coefficients for the one-sided beam sweeping based on the beam sweeping configuration. The one-sided beam sweeping may be performed based further on the second plurality of meta-element coefficients. In another configuration, the network node may identify a second plurality of meta-element coefficients for the two-sided beam sweeping based on the beam sweeping configuration. The two-sided beam sweeping may be performed based further on the second plurality of meta-element coefficients.

In one configuration, referring to FIG. 12, the beam sweeping configuration at 1210 may include one or more indications of at least one of an incident angle, a range of reflection angles, or a range of transmissive angles.

In one configuration, referring to FIG. 12, the at least one reference signal at 1212 may include at least one of a CSI-RS or an SSB. The channel at 1226 may include a PDSCH or a PUSCH.

In one configuration, referring to FIG. 12, the network node 1204 may be an H-RIS.

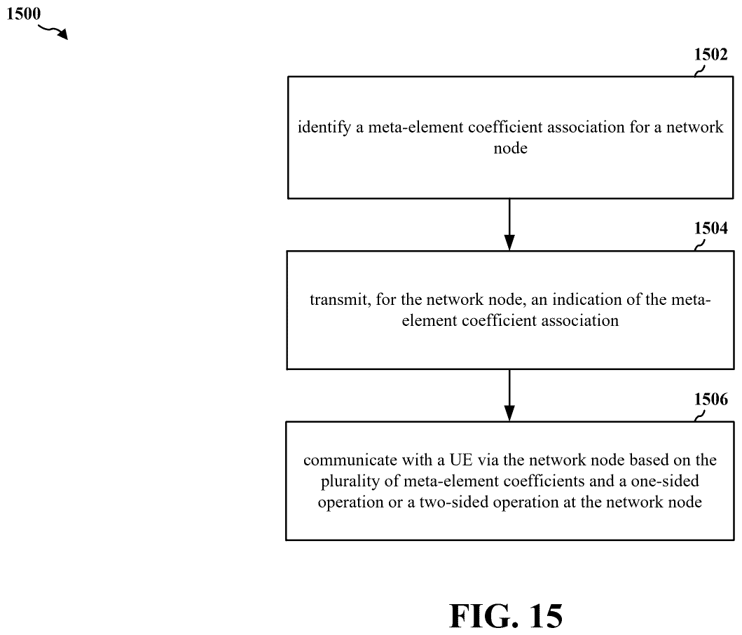

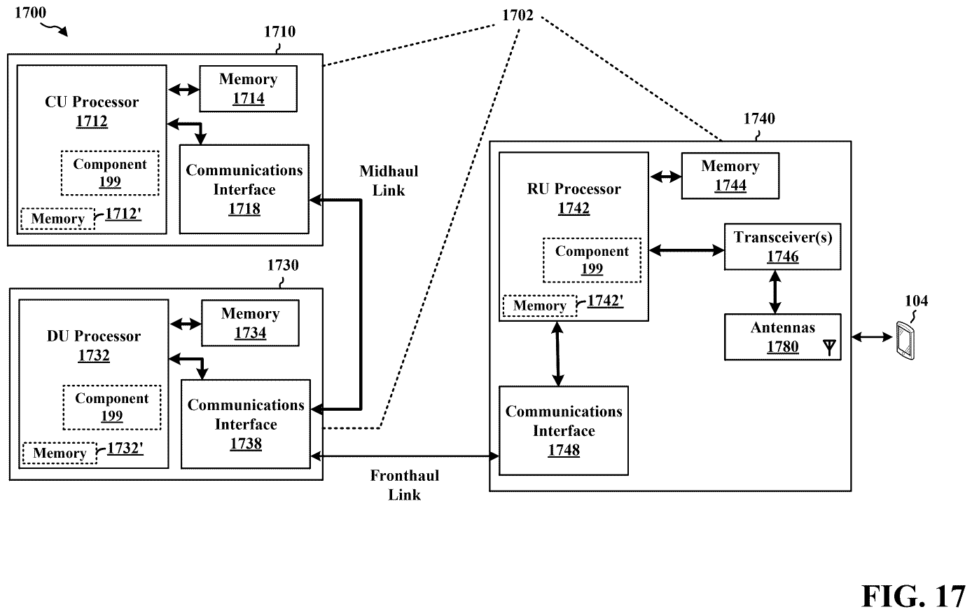

FIG. 15 is a flowchart 1500 of a method of wireless communication. The method may be performed a by network entity (e.g., the baes station 102/310/412/452/512/552/602/702/812/852/902/1002; the network entity 1202/1702/1802). At 1502, the network entity may identify a meta-element coefficient association for a network node. For example, 1502 may be performed by the component 199 in FIG. 17. Referring to FIG. 12, at 1218, the network entity 1202 may identify a meta-element coefficient association for a network node 1204.

At 1504, the network entity may transmit, for the network node, an indication of the meta-element coefficient association. For example, 1504 may be performed by the component 199 in FIG. 17. Referring to FIG. 12, at 1220, the network entity 1202 may transmit, for the network node 1204, an indication of the meta-element coefficient association.

At 1506, the network entity may communicate with a UE via the network node based on a plurality of meta-element coefficients and a one-sided operation or a two-sided operation at the network node. The plurality of meta-element coefficients may be based on the meta-element coefficient association and at least one reference signal. A channel may be forwarded from the network entity for the UE or from the UE for the network entity via the network node based on the plurality of meta-element coefficients and the one-sided operation or the two-sided operation at the network node. For example, 1506 may be performed by the component 199 in FIG. 17. Referring to FIG. 12, at 1226, the network entity 1202 may communicate with a UE 1206 via the network node 1204 based on a plurality of meta-element coefficients and a one-sided operation or a two-sided operation at the network node 1204.

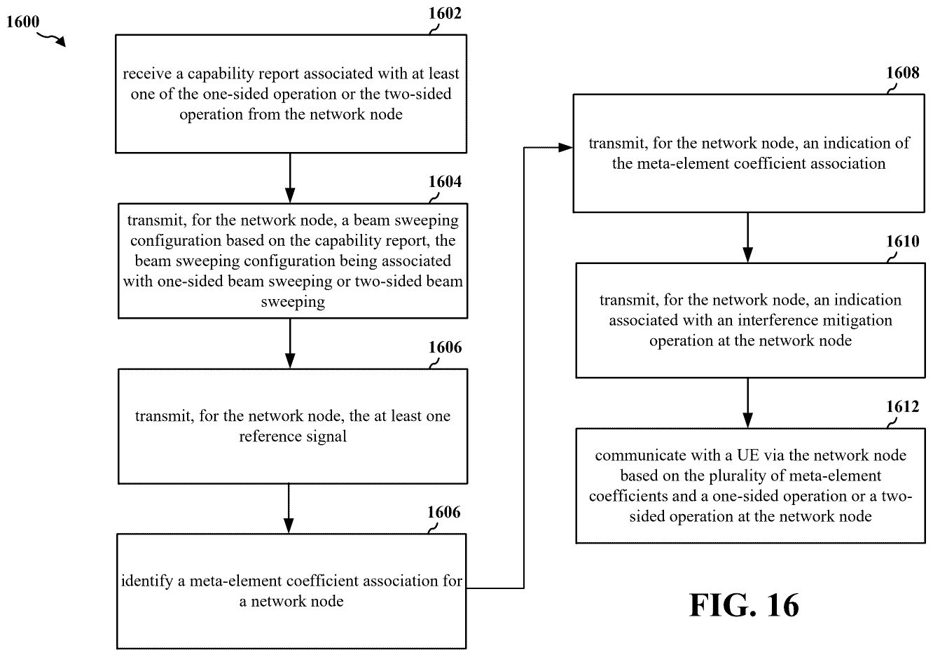

FIG. 16 is a flowchart 1600 of a method of wireless communication. The method may be performed by network entity a (e.g., the baes station 102/310/412/452/512/552/602/702/812/852/902/1002; the network entity 1202/1702/1802). At 1606, the network entity may identify a meta-element coefficient association for a network node. For example, 1606 may be performed by the component 199 in FIG. 17. Referring to FIG. 12, at 1218, the network entity 1202 may identify a meta-element coefficient association for a network node 1204.

At 1608, the network entity may transmit, for the network node, an indication of the meta-element coefficient association. For example, 1608 may be performed by the component 199 in FIG. 17. Referring to FIG. 12, at 1220, the network entity 1202 may transmit, for the network node 1204, an indication of the meta-element coefficient association.

At 1612, the network entity may communicate with a UE via the network node based on a plurality of meta-element coefficients and a one-sided operation or a two-sided operation at the network node. The plurality of meta-element coefficients may be based on the meta-element coefficient association and at least one reference signal. A channel may be forwarded from the network entity for the UE or from the UE for the network entity via the network node based on the plurality of meta-element coefficients and the one-sided operation or the two-sided operation at the network node. For example, 1612 may be performed by the component 199 in FIG. 17. Referring to FIG. 12, at 1226, the network entity 1202 may communicate with a UE 1206 via the network node 1204 based on a plurality of meta-element coefficients and a one-sided operation or a two-sided operation at the network node 1204.

In one configuration, referring to FIG. 12, the channel may be forwarded, at 1226, based on the one-sided operation. The channel may be forwarded, at 1226, based on one of reflection or refraction at the network node 1204.

In one configuration, referring to FIG. 12, the at least one reference signal at 1212 may be associated with two sides of the network node 1204. The indication of the meta-element coefficient association at 1220 may further include an indication of a single side of the network node 1204 associated with the one-sided operation.

In one configuration, at 1610, the network entity may transmit, for the network node, an indication associated with an interference mitigation operation at the network node. For example, 1610 may be performed by the component 199 in FIG. 17. Referring to FIG. 12, at 1222, the network entity 1202 may transmit, for the network node 1204, an indication associated with an interference mitigation operation at the network node 1204.

In one configuration, referring to FIG. 12, the channel may be forwarded, at 1226, based on the two-sided operation. The channel may be forwarded, at 1226, based on both of reflection and refraction at the network node 1204.

In one configuration, referring to FIG. 12, the at least one reference signal at 1212 may include a single reference signal associated with two sides of the network node 1204. The indication of the meta-element coefficient association at 1220 may further include an indication of the single reference signal.

In one configuration, referring to FIG. 12, the at least one reference signal at 1212 may include two reference signals each associated with one of two sides of the network node 1204. The indication of the meta-element coefficient association at 1220 may further include an indication of the two reference signals.

In one configuration, at 1602, the network entity may receive a capability report associated with at least one of the one-sided operation or the two-sided operation from the network node. For example, 1602 may be performed by the component 199 in FIG. 17. Referring to FIG. 12, at 1208, the network entity 1202 may receive a capability report associated with at least one of the one-sided operation or the two-sided operation from the network node 1204.

At 1604, the network entity may transmit, for the network node, a beam sweeping configuration based on the capability report. The beam sweeping configuration may be associated with one-sided beam sweeping or two-sided beam sweeping. For example, 1604 may be performed by the component 199 in FIG. 17. Referring to FIG. 12, at 1210, the network entity 1202 may transmit, for the network node 1204, a beam sweeping configuration based on the capability report at 1208.

At 1606, the network entity may transmit, for the network node, the at least one reference signal. The one-sided beam sweeping or the two-sided beam sweeping may be based on the beam sweeping configuration and the at least one reference signal. For example, 1606 may be performed by the component 199 in FIG. 17. Referring to FIG. 12, at 1212, the network entity 1202 may transmit, for the network node 1204, the at least one reference signal.

In one configuration, referring to FIG. 12, the capability report at 1208 may include an indication of an interference mitigation capability associated with the one-sided operation.

In one configuration, referring to FIG. 12, the beam sweeping configuration at 1210 may be associated with the one-sided beam sweeping. The beam sweeping configuration at 1210 may include an indication associated with an interference mitigation operation based on the interference mitigation capability.

In one configuration, a second plurality of meta-element coefficients for the one-sided beam sweeping or the two-sided beam sweeping may be based on the beam sweeping configuration at 1210. The one-sided beam sweeping or the two-sided beam sweeping at 1216 may be based further on the second plurality of meta-element coefficients.

In one configuration, referring to FIG. 12, the beam sweeping configuration at 1210 may include one or more indications of at least one of an incident angle, a range of reflection angles, or a range of transmissive angles.

In one configuration, referring to FIG. 12, the at least one reference signal at 1212 may include at least one of a CSI-RS or an SSB. The channel at 1226 may include a PDSCH or a PUSCH.

In one configuration, referring to FIG. 12, the network node 1204 may be an H-RIS.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to identify a meta-element coefficient association for a network node. The component 199 may be configured to transmit, for the network node, an indication of the meta-element coefficient association. The component 199 may be configured to communicate with a UE via the network node based on a plurality of meta-element coefficients and a one-sided operation or a two-sided operation at the network node. The plurality of meta-element coefficients may be based on the meta-element coefficient association and at least one reference signal. A channel may be forwarded from the network entity for the UE or from the UE for the network entity via the network node based on the plurality of meta-element coefficients and the one-sided operation or the two-sided operation at the network node. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 may include means for identifying a meta-element coefficient association for a network node. The network entity 1702 may include means for transmitting, for the network node, an indication of the meta-element coefficient association. The network entity 1702 may include means for communicating with a UE via the network node based on a plurality of meta-element coefficients and a one-sided operation or a two-sided operation at the network node. The plurality of meta-element coefficients may be based on the meta-element coefficient association and at least one reference signal. A channel may be forwarded from the network entity for the UE or from the UE for the network entity via the network node based on the plurality of meta-element coefficients and the one-sided operation or the two-sided operation at the network node.

In one configuration, the channel may be forwarded based on the one-sided operation. The channel may be forwarded based on one of reflection or refraction at the network node. In one configuration, the at least one reference signal may be associated with two sides of the network node. The indication of the meta-element coefficient association may further include an indication of a single side of the network node associated with the one-sided operation. In one configuration, the network entity 1702 may include means for transmitting, for the network node, an indication associated with an interference mitigation operation at the network node. In one configuration, the channel may be forwarded based on the two-sided operation. The channel may be forwarded based on both of reflection and refraction at the network node. In one configuration, the at least one reference signal may include a single reference signal associated with two sides of the network node. The indication of the meta-element coefficient association may further include an indication of the single reference signal. In one configuration, the at least one reference signal may include two reference signals each associated with one of two sides of the network node. The indication of the meta-element coefficient association may further include an indication of the two reference signals. In one configuration, the network entity 1702 may include means for receiving a capability report associated with the one-sided operation from the network node. The network entity 1702 may include means for transmitting, for the network node, a beam sweeping configuration based on the capability report. The beam sweeping configuration may be associated with one-sided beam sweeping. The network entity 1702 may include means for transmitting, for the network node, the at least one reference signal. The one-sided beam sweeping may be based on the beam sweeping configuration and the at least one reference signal. In one configuration, the capability report may include an indication of an interference mitigation capability associated with the one-sided operation. The beam sweeping configuration may be associated with the one-sided beam sweeping. The beam sweeping configuration may include an indication associated with an interference mitigation operation based on the interference mitigation capability. In one configuration, a second plurality of meta-element coefficients for the one-sided beam sweeping may be based on the beam sweeping configuration. The one-sided beam sweeping may be based further on the second plurality of meta-element coefficients. In one configuration, the beam sweeping configuration may include one or more indications of at least one of an incident angle, a range of reflection angles, or a range of transmissive angles. In one configuration, the network entity 1702 may include means for receiving a capability report associated with the two-sided operation from the network node. The network entity 1702 may include means for transmitting, for the network node, a beam sweeping configuration based on the capability report. The beam sweeping configuration may be associated with two-sided beam sweeping. The network entity 1702 may include means for transmitting, for the network node, the at least one reference signal. The two-sided beam sweeping may be based on the beam sweeping configuration and the at least one reference signal. In one configuration, the at least one reference signal may include at least one of a CSI-RS or an SSB. The channel may include a PDSCH or a PUSCH. In one configuration, the network node may be an H-RIS.

The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 18 is a diagram 1800 illustrating an example of a hardware implementation for a network entity 1860. In one example, the network entity 1860 may be within the core network 120. The network entity 1860 may include a network processor 1812. The network processor 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The processor 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive an indication of a meta-element coefficient association from a network entity. The component 198 may be configured to identify a plurality of meta-element coefficients based on the meta-element coefficient association and at least one reference signal. The component 198 may be configured to forward a channel from the network entity for a UE or from the UE for the network entity based on the plurality of meta-element coefficients and a one-sided operation or a two-sided operation. The component 198 may be within the processor 1812. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1860 may include a variety of components configured for various functions. In one configuration, the network entity 1860 may include means for receiving an indication of a meta-element coefficient association from a network entity. The network entity 1860 may include means for identifying a plurality of meta-element coefficients based on the meta-element coefficient association and at least one reference signal. The network entity 1860 may include means for forwarding a channel from the network entity for a UE or from the UE for the network entity based on the plurality of meta-element coefficients and a one-sided operation or a two-sided operation.

In one configuration, the channel may be forwarded based on the one-sided operation. The channel may be forwarded based on one of reflection or refraction at the network node. In one configuration, the at least one reference signal may be associated with two sides of the network node. The indication of the meta-element coefficient association may further include an indication of a single side of the network node associated with the one-sided operation. In one configuration, the network entity 1860 may include means for receiving an indication associated with an interference mitigation operation at the network node from the network entity. In one configuration, the channel may be forwarded based on the two-sided operation. The channel may be forwarded based on both of reflection and refraction at the network node. In one configuration, the at least one reference signal may include a single reference signal associated with two sides of the network node. The indication of the meta-element coefficient association may further include an indication of the single reference signal. In one configuration, the at least one reference signal may include two reference signals each associated with one of two sides of the network node. The indication of the meta-element coefficient association may further include an indication of the two reference signals. In one configuration, the network entity 1860 may include means for transmitting, for the network entity, a capability report associated with the one-sided operation. The network entity 1860 may include means for receiving a beam sweeping configuration from the network entity based on the capability report. The beam sweeping configuration may be associated with one-sided beam sweeping. The network entity 1860 may include means for receiving the at least one reference signal from the network entity. The network entity 1860 may include means for performing the one-sided beam sweeping based on the beam sweeping configuration and the at least one reference signal. In one configuration, the capability report may include an indication of an interference mitigation capability associated with the one-sided operation. The beam sweeping configuration may be associated with the one-sided beam sweeping. The beam sweeping configuration may include an indication associated with an interference mitigation operation based on the interference mitigation capability. In one configuration, the network entity 1860 may include means for identifying a second plurality of meta-element coefficients for the one-sided beam sweeping based on the beam sweeping configuration. The one-sided beam sweeping may be performed based further on the second plurality of meta-element coefficients. In one configuration, the beam sweeping configuration may include one or more indications of at least one of an incident angle, a range of reflection angles, or a range of transmissive angles. In one configuration, the network entity 1860 may include means for transmitting, for the network entity, a capability report associated with the two-sided operation. The network entity 1860 may include means for receiving a beam sweeping configuration from the network entity based on the capability report. The beam sweeping configuration being associated with two-sided beam sweeping. The network entity 1860 may include means for receiving the at least one reference signal from the network entity. The network entity 1860 may include means for performing the two-sided beam sweeping based on the beam sweeping configuration and the at least one reference signal. In one configuration, the at least one reference signal may include at least one of a CSI-RS or an SSB. The channel may include a PDSCH or a PUSCH. In one configuration, the network node may be an H-RIS.

The means may be the component 198 of the network entity 1860 configured to perform the functions recited by the means.

Referring back to FIGS. 4-18, a network entity (e.g., a base station) may identify a meta-element coefficient association for a network node (e.g., an H-RIS). The network entity may transmit, for the network node, an indication of the meta-element coefficient association. The network node may identify a plurality of meta-element coefficients based on the meta-element coefficient association and at least one reference signal. The network node may forward a channel from the network entity for a UE or from the UE for the network entity based on the plurality of meta-element coefficients and a one-sided operation or a two-sided operation. Accordingly, a protocol and signaling design to enable H-RIS based comminution may be provided. The protocol and signaling design may relate to the H-RIS capability report, the two-sided beam sweeping at the H-RIS, and/or the H-RIS meta-element coefficient association indication for the downlink and/or the uplink.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network node, including receiving an indication of a meta-element coefficient association from a network entity; identifying a plurality of meta-element coefficients based on the meta-element coefficient association and at least one reference signal; and forwarding a channel from the network entity for a UE or from the UE for the network entity based on the plurality of meta-element coefficients and a one-sided operation or a two-sided operation.

Aspect 2 is the method of aspect 1, where the channel is forwarded based on the one-sided operation, and the channel is forwarded based on one of reflection or refraction at the network node.

Aspect 3 is the method of aspect 2, where the at least one reference signal is associated with two sides of the network node, and the indication of the meta-element coefficient association further includes an indication of a single side of the network node associated with the one-sided operation.

Aspect 4 is the method of any of aspects 2 and 3, further including: receiving an indication associated with an interference mitigation operation at the network node from the network entity.

Aspect 5 is the method of aspect 1, where the channel is forwarded based on the two-sided operation, and the channel is forwarded based on both of reflection and refraction at the network node.

Aspect 6 is the method of aspect 5, where the at least one reference signal includes a single reference signal associated with two sides of the network node, and the indication of the meta-element coefficient association further includes an indication of the single reference signal.

Aspect 7 is the method of aspect 5, where the at least one reference signal includes two reference signals each associated with one of two sides of the network node, and the indication of the meta-element coefficient association further includes an indication of the two reference signals.

Aspect 8 is the method of any of aspects 1 to 4, further including: transmitting, for the network entity, a capability report associated with the one-sided operation; receiving a beam sweeping configuration from the network entity based on the capability report, the beam sweeping configuration being associated with one-sided beam sweeping; receiving the at least one reference signal from the network entity; and performing the one-sided beam sweeping based on the beam sweeping configuration and the at least one reference signal.

Aspect 9 is the method of aspect 8, where the capability report includes an indication of an interference mitigation capability associated with the one-sided operation, the beam sweeping configuration is associated with the one-sided beam sweeping, and the beam sweeping configuration includes an indication associated with an interference mitigation operation based on the interference mitigation capability.

Aspect 10 is the method of any of aspects 8 and 9, further including: identifying a second plurality of meta-element coefficients for the one-sided beam sweeping based on the beam sweeping configuration, where the one-sided beam sweeping is performed based further on the second plurality of meta-element coefficients.

Aspect 11 is the method of any of aspects 8 to 10, where the beam sweeping configuration includes one or more indications of at least one of an incident angle, a range of reflection angles, or a range of transmissive angles.

Aspect 12 is the method of any of aspects 1 and 5 to 7, further including: transmitting, for the network entity, a capability report associated with the two-sided operation; receiving a beam sweeping configuration from the network entity based on the capability report, the beam sweeping configuration being associated with two-sided beam sweeping; receiving the at least one reference signal from the network entity; and performing the two-sided beam sweeping based on the beam sweeping configuration and the at least one reference signal.

Aspect 13 is the method of aspect 12, further including: identifying a second plurality of meta-element coefficients for the two-sided beam sweeping based on the beam sweeping configuration, where the two-sided beam sweeping is performed based further on the second plurality of meta-element coefficients.

Aspect 14 is the method of any of aspects 12 and 13, where the beam sweeping configuration includes one or more indications of at least one of an incident angle, a range of reflection angles, or a range of transmissive angles.

Aspect 15 is the method of any of aspects 1 to 14, where the at least one reference signal includes at least one of a CSI-RS or an SSB, and the channel includes a PDSCH or a PUSCH.

Aspect 16 is the method of any of aspects 1 to 15, where the network node is an H-RIS.

Aspect 17 is a method of wireless communication at a network entity, including identifying a meta-element coefficient association for a network node; transmitting, for the network node, an indication of the meta-element coefficient association; and communicating with a UE via the network node based on a plurality of meta-element coefficients and a one-sided operation or a two-sided operation at the network node, where the plurality of meta-element coefficients is based on the meta-element coefficient association and at least one reference signal, and a channel is forwarded from the network entity for the UE or from the UE for the network entity via the network node based on the plurality of meta-element coefficients and the one-sided operation or the two-sided operation at the network node.

Aspect 18 is the method of aspect 17, where the channel is forwarded based on the one-sided operation, and the channel is forwarded based on one of reflection or refraction at the network node.

Aspect 19 is the method of aspect 18, where the at least one reference signal is associated with two sides of the network node, and the indication of the meta-element coefficient association further includes an indication of a single side of the network node associated with the one-sided operation.

Aspect 20 is the method of any of aspects 18 and 19, further including: transmitting, for the network node, an indication associated with an interference mitigation operation at the network node.

Aspect 21 is the method of aspect 17, where the channel is forwarded based on the two-sided operation, and the channel is forwarded based on both of reflection and refraction at the network node.

Aspect 22 is the method of aspect 11, where the at least one reference signal includes a single reference signal associated with two sides of the network node, and the indication of the meta-element coefficient association further includes an indication of the single reference signal.

Aspect 23 is the method of aspect 21, where the at least one reference signal includes two reference signals each associated with one of two sides of the network node, and the indication of the meta-element coefficient association further includes an indication of the two reference signals.

Aspect 24 is the method of any of aspects 17 to 20, further including: receiving a capability report associated with the one-sided operation from the network node; transmitting, for the network node, a beam sweeping configuration based on the capability report, the beam sweeping configuration being associated with one-sided beam sweeping; and transmitting, for the network node, the at least one reference signal, where the one-sided beam sweeping is based on the beam sweeping configuration and the at least one reference signal.

Aspect 25 is the method of aspect 24, where the capability report includes an indication of an interference mitigation capability associated with the one-sided operation, the beam sweeping configuration is associated with the one-sided beam sweeping, and the beam sweeping configuration includes an indication associated with an interference mitigation operation based on the interference mitigation capability.

Aspect 26 is the method of any of aspects 24 and 25, where a second plurality of meta-element coefficients for the one-sided beam sweeping is based on the beam sweeping configuration, and the one-sided beam sweeping is based further on the second plurality of meta-element coefficients.

Aspect 27 is the method of any of aspects 24 to 26, where the beam sweeping configuration includes one or more indications of at least one of an incident angle, a range of reflection angles, or a range of transmissive angles.

Aspect 28 is the method of any of aspects 17 and 21 to 23, further including: receiving a capability report associated with the two-sided operation from the network node; transmitting, for the network node, a beam sweeping configuration based on the capability report, the beam sweeping configuration being associated with two-sided beam sweeping; and transmitting, for the network node, the at least one reference signal, where the two-sided beam sweeping is based on the beam sweeping configuration and the at least one reference signal.

Aspect 29 is the method of aspect 28, where a second plurality of meta-element coefficients for the two-sided beam sweeping is based on the beam sweeping configuration, and the two-sided beam sweeping is based further on the second plurality of meta-element coefficients.

Aspect 30 is the method of any of aspects 28 and 29, where the beam sweeping configuration includes one or more indications of at least one of an incident angle, a range of reflection angles, or a range of transmissive angles.

Aspect 31 is the method of any of aspects 17 to 30, where the at least one reference signal includes at least one of a CSI-RS or an SSB, and the channel includes a PDSCH or a PUSCH.

Aspect 32 is the method of any of aspects 17 to 31, where the network node is an H-RIS.

Aspect 33 is an apparatus for wireless communication including at least one processor coupled to a memory and, based at least in part on information stored in the memory, the at least one processor is configured to implement a method as in any of aspects 1 to 32.

Aspect 34 may be combined with aspect 33 and further includes a transceiver coupled to the at least one processor.

Aspect 35 is an apparatus for wireless communication including means for implementing any of aspects 1 to 32.

Aspect 36 is a non-transitory computer-readable storage medium storing computer executable code, where the code when executed by a processor causes the processor to implement any of aspects 1 to 32.

Various aspects have been described herein. These and other aspects are within the scope of the following claims.

1. An apparatus for wireless communication at a network node, comprising:
a memory; and
at least one processor coupled to the memory and, based at least in part on information stored in the memory, the at least one processor is configured to:
receive an indication of a meta-element coefficient association from a network entity;
identify a plurality of meta-element coefficients based on the meta-element coefficient association and at least one reference signal; and
forward a channel from the network entity for a user equipment (UE) or from the UE for the network entity based on the plurality of meta-element coefficients and a one-sided operation or a two-sided operation.

2. The apparatus of claim 1, wherein the channel is forwarded based on the one-sided operation, and the channel is forwarded based on one of reflection or refraction at the network node.

3. The apparatus of claim 2, wherein the at least one reference signal is associated with two sides of the network node, and the indication of the meta-element coefficient association further includes an indication of a single side of the network node associated with the one-sided operation.

4. The apparatus of claim 2, the at least one processor being configured to:
receive an indication associated with an interference mitigation operation at the network node from the network entity.

5. The apparatus of claim 1, wherein the channel is forwarded based on the two-sided operation, and the channel is forwarded based on both of reflection and refraction at the network node.

6. (canceled)

7. (canceled)

8. The apparatus of claim 1, the at least one processor being configured to:
transmit, for the network entity, a capability report associated with the one-sided operation;
receive a beam sweeping configuration from the network entity based on the capability report, the beam sweeping configuration being associated with one-sided beam sweeping;
receive the at least one reference signal from the network entity; and
perform the one-sided beam sweeping based on the beam sweeping configuration and the at least one reference signal.

9. (canceled)

10. (canceled)

11. (canceled)

12. The apparatus of claim 1, the at least one processor being configured to:
transmit, for the network entity, a capability report associated with the two-sided operation;
receive a beam sweeping configuration from the network entity based on the capability report, the beam sweeping configuration being associated with two-sided beam sweeping;
receive the at least one reference signal from the network entity; and
perform the two-sided beam sweeping based on the beam sweeping configuration and the at least one reference signal.

13. The apparatus of claim 1, wherein the at least one reference signal includes at least one of a channel state information-reference signal (CSI-RS) or a synchronization signal block (SSB), and the channel includes a physical downlink shared channel (PDSCH) or a physical uplink shared channel (PUSCH).

14. The apparatus of claim 1, further comprising a transceiver coupled to the at least one processor, wherein the network node is a hybrid reconfigurable intelligent surface (H-RIS).

15. A method of wireless communication at a network node, comprising:
receiving an indication of a meta-element coefficient association from a network entity;
identifying a plurality of meta-element coefficients based on the meta-element coefficient association and at least one reference signal; and
forwarding a channel from the network entity for a user equipment (UE) or from the UE for the network entity based on the plurality of meta-element coefficients and a one-sided operation or a two-sided operation.

16. An apparatus for wireless communication at a network entity, comprising:
a memory; and
at least one processor coupled to the memory and, based at least in part on information stored in the memory, the at least one processor is configured to:
identify a meta-element coefficient association for a network node;
transmit, for the network node, an indication of the meta-element coefficient association; and
communicate with a user equipment (UE) via the network node based on a plurality of meta-element coefficients and a one-sided operation or a two-sided operation at the network node,
wherein the plurality of meta-element coefficients is based on the meta-element coefficient association and at least one reference signal, and a channel is forwarded from the network entity for the UE or from the UE for the network entity via the network node based on the plurality of meta-element coefficients and the one-sided operation or the two-sided operation at the network node.

17. The apparatus of claim 16, wherein the channel is forwarded based on the one-sided operation, and the channel is forwarded based on one of reflection or refraction at the network node.

18. The apparatus of claim 17, wherein the at least one reference signal is associated with two sides of the network node, and the indication of the meta-element coefficient association further includes an indication of a single side of the network node associated with the one-sided operation.

19. The apparatus of claim 17, the at least one processor being configured to:
transmit, for the network node, an indication associated with an interference mitigation operation at the network node.

20. The apparatus of claim 16, wherein the channel is forwarded based on the two-sided operation, and the channel is forwarded based on both of reflection and refraction at the network node.

21. The apparatus of claim 20, wherein the at least one reference signal includes a single reference signal associated with two sides of the network node, and the indication of the meta-element coefficient association further includes an indication of the single reference signal.

22. The apparatus of claim 20, wherein the at least one reference signal includes two reference signals each associated with one of two sides of the network node, and
the indication of the meta-element coefficient association further includes an indication of the two reference signals.

23. The apparatus of claim 16, the at least one processor being configured to:
receive a capability report associated with the one-sided operation from the network node;
transmit, for the network node, a beam sweeping configuration based on the capability report, the beam sweeping configuration being associated with one-sided beam sweeping; and
transmit, for the network node, the at least one reference signal,
wherein the one-sided beam sweeping is based on the beam sweeping configuration and the at least one reference signal.

24. The apparatus of claim 23, wherein the capability report includes an indication of an interference mitigation capability associated with the one-sided operation, the beam sweeping configuration is associated with the one-sided beam sweeping, and the beam sweeping configuration includes an indication associated with an interference mitigation operation based on the interference mitigation capability.

25. (canceled)

26. (canceled)

27. The apparatus of claim 16, the at least one processor being configured to:
receive a capability report associated with the two-sided operation from the network node;
transmit, for the network node, a beam sweeping configuration based on the capability report, the beam sweeping configuration being associated with two-sided beam sweeping; and
transmit, for the network node, the at least one reference signal,
wherein the two-sided beam sweeping is based on the beam sweeping configuration and the at least one reference signal.

28. (canceled)

29. (canceled)

30. (canceled)
